(19) United States
(12) Patent Application Publication
(10) Pub. No.: US 2019/0385493 A1
(43) Pub. Date: Dec. 19, 2019

(54) LIGHT DISTRIBUTION METHOD FOR ADVERTISING LAMP BOX AND ADVERTISING LAMP BOX

(71) Applicant: Ningbo Levi Lighting Technology Co., Ltd, Ningbo City (CN)

(72) Inventor: Haiqiang LEI, Ningbo City (CN)

(21) Appl. No.: 16/219,383

(22) Filed: Dec. 13, 2018

(30) Foreign Application Priority Data
Jun. 15, 2018 (CN) 201810621379.6

(51) Int. Cl. G09F 13/22; F21V 5/00; F21K 9/278; G09F 13/04; G09F 13/18

(52) U.S. Cl. CPC G09F 13/22; F21V 5/008; F21K 9/278; G09F 2013/222; G09F 13/18; G09F 2013/049; G09F 13/0413

(57) ABSTRACT

A light distribution method for an advertising lamp box and an advertising lamp box are disclosed. The light distribution method comprises a step of edge lighting and a step of middle lighting, comprising: lighting from an inner wall of a frame to the middle, and lighting on two sides in the middle of the inner portion of the advertising lamp box. With the same effect as conventional lighting tools, the light distribution method of the present invention has the advantages of environmental friendliness, firmly fixed lenses which are not easy to fall off, high structural strength enough to be applied to large lamp boxes, low labor cost of mounting, and so on.

### TECHNICAL FIELD

The present invention relates to the field of advertising equipment technologies, and in particular, to a light distribution method for an advertising lamp box and an advertising lamp box.

### BACKGROUND ART

Lighting is an indispensable demand in human society production and industrial production. Since Edison invented the incandescent lamp, lighting has been popularized on a large scale. Up to now, mainstream electric lighting technologies include the following: incandescent lamp lighting, fluorescent lamp lighting and LED lighting. At present, the incandescent lamp has been basically eliminated and is still retained only in some special fields. The fluorescent lamp lighting is the current mainstream; although it is being gradually replaced by the LED, it still dominates the current market mainly because of its mature production technology and extremely low cost of equipment purchasing. The LED lighting is being used more widely because of its higher energy efficiency than the fluorescent lamp.

However, the LED still has no obvious advantages over the conventional fluorescent lighting in some special fields. For example, the fluorescent lamp is still dominating at present in a lighting system (that is, the general name of a lighting lamp that has a lighting effect and relevant fittings) of an advertising lamp box. Although there are a few solutions using LED lights as alternatives, they also have obvious defects. For example, a single LED light bar has a small light angle, and the lighting effect is inferior to the fluorescent lamp, which is because the fluorescent lamp emits light at 360°. Therefore, the fluorescent lamp has excellent application in lamp box lighting, while the conventional LED lamp is incapable of high-power lighting because of heat generation, and its light angle is less than the fluorescent lamp. As a result, when the existing LED lamp is used to replace the fluorescent lamp in lamp box lighting, replacement shall be carried out with a ratio of at least 2:1, that is, one fluorescent lamp tube shall be replaced with two or more LED light bars, so as to avoid the occurrence of an alternately bright and dark lighting defect as zebra strips from affecting the overall lighting effect of the lamp box.

In another aspect, the existing LED lamps for lamp box lighting are often attached with small lenses to scatter light emitted by LED beads to improve luminous lighting effects, which alleviates the above defects to some extent but does not fundamentally solve this problem. Moreover, this brings about an additional problem: the lens is glued to a PCB board and part of the lens will fall off in the transportation or mounting process, which will not only affect the appearance but also affect the lighting effect. The problem has not been completely solved in the industry, affecting the reliability and market share of LED products in advertising lighting.

In the third aspect, the labor cost of mounting should also be taken into account. After the replacement with LED lamps, the number of corresponding lamp tubes increases exponentially, thus significantly increasing the labor costs of subsequent mounting and maintenance. This will lead to a significant increase in the overall comprehensive cost of products for both the Chinese market where labor costs continue to grow and the market of developed countries where labor costs are already high.

Therefore, the LED lighting solutions in the prior art are not well qualified for the special field of lamp box lighting.

### SUMMARY OF THE INVENTION

An objective of the present invention is to provide a novel light distribution method for an advertising lamp box and an advertising lamp box. The light distribution method can significantly reduce the labor costs of mounting and maintenance in the early stage, and the LED light distribution lamps used in the method further have the advantages such as environmental friendliness, firmly fixed lenses which are not easy to fall off, high structural strength, and so on. The overall cost of the advertising lamp box obtained by the light distribution method is significantly reduced.

In order to achieve the foregoing objective, the present invention adopts the following solutions:

A light distribution method for an advertising lamp box includes a step of edge lighting and a step of middle lighting.

The step of edge lighting includes: disposing an LED light bar capable of single-sided lighting (i.e., a single-sided lighting LED light bar) along an inner wall of a lamp box frame in the advertising lamp box. The single-sided lighting LED light bar can be configured to be a long flat strip with one of the flat surfaces capable of emitting light and the other not emitting light. The single-sided lighting LED light bar is configured to be fixed onto the inner wall of the lamp box frame in a manner that an illuminated area faces the inner of the lamp box and a back surface faces the lamp box frame, so that the LED light bar can light from the inner wall of the frame to the middle.

The step of middle lighting includes: disposing several double-sided lighting LED light bars (i.e., the double-sided lighting LED light bars) in the middle of the inner portion of the advertising lamp box. The double-sided lighting LED light bars are also in the shape of a long flat strip, and two flat surfaces of the double-sided lighting LED light bar can both light. Two ends of each double-sided lighting LED light bar are fixed onto the lamp box frame, so that the LED light bar can light on two sides.

A central plane of illuminated areas of the single-sided lighting LED light bar and the double-sided lighting LED light bars is configured to be parallel to or nearly parallel to an advertising surface of the advertising lamp box. The core of the light distribution method lies in that: in each illumination range, the illumination light does not directly light on the back of the advertising surface, but lights from at least two opposite end faces of the illumination range respectively, thereby the illumination range is fully illuminated to further illuminate the back of the advertising surface (it can be understood as that first the illumination range is illuminated by the single-sided lighting LED light bar and the double-sided lighting LED light bars and then the advertising surface is illuminated by the illumination range).

Therefore, the lighting effect of the light distribution method is more uniform and excessively bright or excessively dark lighting effects in local areas will not be produced. Definitely, the overall shape of the single-sided lighting LED light bar and the double-sided lighting LED light bars is not limited to the long flat strip described above, and other similar shapes that can implement such a function are also allowed.

Preferably, the double-sided lighting LED light bars are configured to be disposed in parallel to each other. Optimally, the double-sided lighting LED light bars as well as they and the single-sided lighting LED light bar at the outer end are uniformly disposed, that is, the illumination ranges have substantially equal widths. As such, the lighting effects of the illumination ranges are more consistent with each other.

Further, the single-sided lighting LED light bar is configured to be disposed on an inner wall of a frame parallel to the double-sided lighting LED light bars or disposed in a circle along an inner wall frame of the lamp box. A single-sided lighting LED light bar is disposed on each of two opposite inner walls of a cubic advertising lamp box, and then several double-sided lighting LED light bars are disposed in parallel between the two single-sided lighting LED light bars. In addition, a pair of single-sided lighting LED light bars can be further disposed at the top and the bottom of the frame. In other words, the single-sided lighting LED light bars are disposed in a circle along an inner wall frame of the lamp box to further improve the lighting effect.

Optimally, the single-sided lighting LED light bars and the double-sided lighting LED light bars are configured to be uniformly disposed in the advertising lamp box, and each illumination range is configured to have a width of 2-3 m. The illumination range is an area formed between two adjacent light-emitting surfaces. In other words, a distance between a single-sided lighting LED light bar and a double-sided lighting LED light bar that are adjacent to each other or a distance between two adjacent double-sided lighting LED light bars is configured to be 2-3 m.

The double-sided lighting LED light bars each include a lamp-panel base and an LED lamp panel. The lamp-panel base includes a substrate and a first fixing groove and a second fixing groove that are disposed on two sides of the substrate. The first fixing groove and the second fixing groove each include a clamping part and a limiting part. The clamping part and the limiting part are disposed in the directions of the upper surface and the lower surface of the substrate. The clamping parts, the limiting parts and the substrate coordinate with each other to form fixing parts for accommodating the LED lamp panel. The fixing parts include a first fixing part and a second fixing part that are formed by coordinating the substrate with the clamping part and the limiting part on either side of the upper surface or the lower surface respectively. The first fixing part and the second fixing part each have an opening and an accommodating part. The opening is formed by oppositely extending the limiting parts of the first fixing groove and the second fixing groove, and the accommodating part is enclosed by the clamping parts of the first fixing groove and the second fixing groove and the substrate, so that the width of the opening is less than that of the accommodating part of the fixing part. In other words, the limiting parts of the first fixing groove and the second fixing groove are disposed to extend towards each other so that the openings are smaller than the accommodating parts.

The LED lamp panel includes a PCB board, LED lamp beads and lenses, there are several LED lamp beads sequentially arranged on the PCB board, and the lenses are arranged on the PCB board one-to-one corresponding to the LED lamp beads, so that the PCB board, the LED lamp beads and the lenses can form the LED lamp panel for lighting after combination. The lenses each include a truncated conical light distribution body and a fixture seat disposed below the light distribution body, and the fixture seat is larger than the light distribution body. A bottom surface of the fixture seat and the PCB board are respectively provided with positioning mechanisms mutually matched with each other, so that the displacement of the lenses along the surface of the PCB board is prevented. There are two LED lamp panels disposed back to back in the first fixing part and the second fixing part, respectively, so that the LED light bars can light on two sides. The first fixing part and the second fixing part are configured to enable the lenses and the PCB board to be firmly fixed onto the lamp-panel base.

The first fixing part and the second fixing part are configured to enable the lenses and the PCB board to be firmly fixed onto the lamp-panel base. Specifically, the first fixing part and the second fixing part are configured to be capable of integrally accommodating the PCB board and fixture seats of the lenses, that is, the clearance size between the limiting parts and the substrate can accommodate the thicknesses of the PCB board and the fixture seats of the lenses. A distance between two clamping parts (the clamping parts of the first fixing groove and the second fixing groove) can allow the PCB board and the fixture seats of the lenses to be disposed therein. Accordingly, the lenses and the PCB board can be firmly fixed onto the lamp-panel base.

The LED light bar is different from the LED light bar in the prior art in which its lenses are generally fixed to the PCB board by glue bonding. The conventional light bar is complex in the processing technology, high in the processing cost, and not environmentally friendly in the process. A more important problem is that the glue used to bond the lenses will fail due to thermal shock or the severe outdoor environment in a long time of use, thus causing the lenses to fall off. Alternatively, the glue used to bond the lenses is also easily failed if the light bar is vibrated or collided in a long-distance transportation or subsequent mounting process, thus causing the lenses to fall off In actual use, a fallen lens on an LED light bar results in a scrapped product (the comprehensive cost of returning the product to the factory for maintenance is too high, and the product is generally scrapped on site), which will indirectly increase the use cost of users and affect user experience and confidence in use. This problem has not been completely solved in the industry. The lenses of the LED light bar of the present invention are fixed directly through a physical structure without glue, thus having a good fixation effect and being not easy to fall off, and fundamentally solving this problem. Moreover, the lamp-panel base effectively protects the circuit board, electronic components and lenses, improves the reliability of the light bar, reduces the failure rate of the LED light bar, and can greatly improve the user experience and reduce the use cost of the users. In addition, the lamp-panel base with the aluminum alloy structure effectively increases the heat dissipation area of the LED light bar, improves the heat dissipation performance, and can greatly improve the power of the LED light bar and prolong the service life of the LED light bar. The lamp-panel base can significantly improve the overall structural strength of the LED light bar, so that the LED light bar can be made very long. Therefore, the LED light bar is especially suitable for the lighting of large advertising lamp boxes.

Further, the single-sided lighting LED light bar is also composed of a lamp-panel base and an LED lamp panel. Moreover, the specific structure and the fitting relationship of the lamp-panel base and the LED lamp panel are the same as those of the double-sided lighting LED light bars, and their difference merely lies in that the single-sided lighting LED light bar is provided with an LED lamp panel only on one side (that is, only one of the first fixing part and the second fixing part is provided with an LED lamp panel while the other one is vacant), so that the LED light bar only can light on one side. In addition, the lamp-panel base can also make some simple structural changes so that the back surface (that is, one side without the LED lamp panel) is a flat structure. Without changing the first fixing groove and the second fixing groove structurally, the substrate can be sunk towards the back surface by an appropriate distance so that the back surface of the substrate of the lamp panel is completely flat (at the same time, the thickness of the fixing part of the lens is increased correspondingly), or the substrate is unchanged but related structures of the first fixing groove and the second fixing groove are contracted correspondingly. In the former manner, the overall sizes of the single-sided lighting LED light bar and the double-sided lighting LED light bar remain unchanged and the thickness of LED lamp panel needs to be increased correspondingly. In the latter manner, the single-sided lighting LED light bar and the double-sided lighting LED light bar differ from each other slightly in the thickness, but their LED lamp panels are exactly the same in the specification. In general, the most economical solution is to make the back surface vacant.

Further, the first fixing groove and the second fixing groove each further include two fins (the first fixing groove and the second fixing groove each have two fins disposed on the top and bottom). One end of each fin is fixed to a junction of the clamping part and the limiting part and the other end of the fin extends outwards, and an L-shaped bend is formed at the outer end of the fin (that is, the end that extends outwards). The profile of the four fins is configured so that the lamp-panel base is still integrally in the shape of a long flat strip (that is, the sectional thickness of the lamp-panel base remains unchanged and only the width is increased). For this reason, the fins on the top and bottom of the first fixing groove and the second fixing groove extend outwards straightly and then bend oppositely to form the L-shaped bend.

More preferably, upper and lower fins of the first fixing groove or the second fixing groove are coordinated to form a chute for fixing the entire LED light bar. In other words, the chute is formed by fitting the bends at the L-shaped outer ends of the upper and lower fins of the first fixing groove or the second fixing groove. An LED light bar fixing device is configured to be fitted in the chute to fix the entire LED light bar. The LED light bar fixing device includes an extending member and a fixing screw. A first end of the extending member is strip-shaped and is slidably fitted in the chute. The first end is provided with a fixing hole for disposing the fixing screw, and a second end of the extending member is provided with a mounting hole. The extending member is integrally L-shaped, but it can specifically include two types of specific structures. In the first type of structure, the first end and the second end are end-to-end connected and form an angle of 90° or close to 90°. In the second type of structure, the second end is fitted to a side of the first end, and the second end and the first end form an angle of 90° or close to 90°. The former can be used to fix the LED light bar to a to-be-fixed position at its end portion, and the latter can be used to fix the LED light bar to a to-be-fixed position on its back surface.

Further, the first fixing groove and the second fixing groove each further include a thread groove, the thread groove is disposed in the middle of the first fixing groove or the second fixing groove, and includes two ribs and a cylindrical through groove disposed between the two ribs. The cylindrical through groove is formed by a gap between the two ribs. The lamp-panel base is provided with block pieces of the base disposed on two ends, and the block pieces of the base are provided with fixing holes so that they are fixed in two ends of the through groove of the thread groove via the fixing screws. The block pieces of the bases are mainly used to block off two ends of the LED lamp panel after the LED lamp panel is mounted in the fixing part, thereby firmly fixing the LED lamp panel and its components in the fixing part. More preferably, the LED lamp panel further includes a wire clip. The wire clip is provided with a line hole for wires to pass through and a fixing groove for fixing the wire clip. The fixing groove is fitted to the extending part to allow the wire clip to be slidably fitted in the first fixing part or the second fixing part. The wire clip is fitted on the lamp-panel base to fix a power line of the LED lamp panel, thus preventing a connection between the power line and the PCB board from being damaged due to manual pulling of the power line in the mounting process. The positioning mechanisms on the fixture seat of the lens and the PCB board are a positioning column and a positioning hole respectively, or other relevant structures in the prior art that can match with each other to fix the lens and the PCB board.

Preferably, the substrate, the first fixing groove and the second fixing groove may be formed as a whole, and may also be manufactured separately and then connected together by welding or clamping. Optimally, components of the lamp-panel base, that is, the substrate, the first fixing groove, the second fixing groove, the thread groove and the fins, are formed as a whole and are integrally manufactured by aluminum alloy extrusion or machining. On the one hand, such a structure can further enhance the mechanical strength of the lamp-panel base; on the other hand, it also provides a possibility for the setting of relevant accessories of the lamp-panel base or the fixation of the lamp-panel base, so that the fins have stronger mechanical properties and the LED lamp can have a longer length without bending and deformation. It is conducive to promoting the overall heat dissipation performance of the LED lamp. Moreover, the structures of the clamping parts, the limiting parts, the fins and the fixing grooves in the structure and their setting positions greatly improve the overall structural strength of the lamp-panel base. This makes it possible for the LED lamp to be manufactured into a long length so as to be suitable for large billboards.

An advertising lamp box is provided. The advertising lamp box includes a box body and a lighting system. The lighting system includes LED light distribution lamps. The LED light distribution lamps are disposed in the box body by the light distribution method described above. In other words, the advertising lamp box includes a box body and LED light distribution lamps. The box body is generally cubic or approximately cubic (e.g., having rounded corners), and can be a complete box body or a frame that does not include an advertising placement surface. The LED light distribution lamps include double-sided LED light bars and single-sided LED light bars. The single-sided LED light bars are mounted to two ends of the box body in such a manner that the illuminated area faces the inner of the box body and the back surface faces the wall of the box body, while the double-sided LED light bars are mounted in the middle of the inner portion of the box body in such a way that two sides face two box walls respectively. It should be noted that in principle, mounting directions of the LED light distribution lamps do not need to be strictly required, as long as the LED light distribution lamps are parallel to each other. They can be mounted horizontally or vertically, but generally vertical mounting is better. The specific structures of the double-sided LED light bars and the single-sided LED light bars are configured according to the manner in the light distribution method, and are not described in detail here.

The light distribution method of the present invention has the following advantages:

1. In the same lighting brightness, the working hour required by mounting of the light bars at the beginning of the lamp box and the working hour required by subsequent maintenance and replacement of the light bars can be significantly reduced, and the labor cost can be greatly reduced.

2. The positioning column at the bottom of the lens is matched with the positioning hole on the PCB board, and supplemented by the limiting part on the lamp-panel base, the lens is completely fixed through a physical structure. The lens is firm and not easy to fall off, avoiding affecting the overall yield due to falling off of the lens that may be caused by the conventional glue bonding manner.

3. The lens is fixed completely without glue, which is environmentally friendly and also reduces the material cost to some extent. In addition, because there is no glue coating and heating processes, process steps are reduced, the production cost is reduced and the production efficiency is improved. The overall cost in terms of raw material consumption, coating equipment and other aspects is positively impacted, and the effect is gradually prominent in the current trend of increasingly higher requirements on environmental protection.

4. The lamp-panel base not only enhances the overall structural strength of the light bar, but also increases the heat dissipation efficiency. Compared with the light bar without the lamp-panel base, the heat dissipation efficiency of the light bar of the present invention is increased by about 40%. As is known to all, an excessively high working temperature is the main obstacle to the service life of the LED lamp. Therefore, the light bar of the present invention has a service life increased by about 30% to 40% compared with an ordinary LED lamp.

### BRIEF DESCRIPTION OF THE DRAWINGS

FIG. 1 is a schematic structural diagram of a 3 m*3 m advertising lamp box;

FIG. 2 is a schematic structural diagram when the lamp box of FIG. 1 is illuminated by using fluorescent lamp tubes;

FIG. 3 is a schematic structural diagram when the lamp box of FIG. 1 is illuminated by using existing LED light bars;

FIG. 4 is a schematic structural diagram when the lamp box of FIG. 1 uses the light distribution method of the present invention;

FIG. 5 is another schematic structural diagram when the lamp box of FIG. 1 uses the light distribution method of the present invention;

FIG. 6 is a schematic diagram of lighting of an embodiment of FIG. 2;

FIG. 7 is a schematic diagram of lighting of an embodiment of FIG. 3;

FIG. 8 is a schematic diagram of lighting of Embodiments 4 and 5;

FIG. 9 is a schematic diagram of a central plane of illuminated areas of LED light bars according to the present invention;

FIG. 10 is a schematic diagram of an overall structure of LED light bars according to Embodiment 1;

FIG. 11 is a simplified enlarged structural diagram of an embodiment of FIG. 10;

FIG. 12 is a partially enlarged diagram of FIG. 11;

FIG. 13 is a sectional view of a lamp-panel base of Embodiment 1 of FIG. 10;

FIG. 14 is an overall sectional view of an LED light bar of Embodiment 1 of FIG. 10;

FIG. 15a to FIG. 15c are three schematic structural diagrams of a lens of Embodiment 1 of FIG. 10;

FIG. 16a to FIG. 16c are three schematic three-dimensional structural diagrams of the lens;

FIG. 17 is a schematic structural diagram of a bottom surface of the lens of FIG. 15a;

FIG. 18 is a schematic structural diagram of an end portion of the LED light bar according to Embodiment 1;

FIG. 19a and FIG. 19b are two schematic structural diagrams of a wire clip;

FIG. 20 is a schematic structural diagram of a fixing device;

FIG. 21 is another schematic structural diagram of the fixing device;

FIG. 22 is an overall sectional view of a single-sided lighting LED light bar according to Embodiment 1; and

FIG. 23 is a sectional view of a lamp-panel base of a single-sided lighting LED light bar according to Embodiment 2.

### DETAILED DESCRIPTION

In order to enable those skilled in the art to better understand the present invention and to define more clearly the scope for which protection is sought by the present invention, the present invention is described in detail below through some specific embodiments of the present invention. It should be noted that the following are only some specific implementation manners of the conception of the present invention, which are only some embodiments of the present invention. The specific and direct descriptions about related structures are merely for the convenience of understanding the present invention, and the specific features do not definitely and directly limit the scope of implementation of the present invention. Routine selections and replacements made by those skilled in the art under the guidance of the conception of the present invention shall be deemed to be within the scope for which protection is sought by the present invention.

A light distribution method for an advertising lamp box includes a step of edge lighting and a step of middle lighting.

The step of edge lighting includes: disposing a single-sided lighting LED light bar along an inner wall of a lamp box frame in the advertising lamp box. The single-sided lighting LED light bar is a long flat strip with one of the flat surfaces capable of emitting light and the other not emitting light. The single-sided lighting LED light bar is configured such that an illuminated area faces the inner of the lamp box and a back surface faces the lamp box frame, so that the LED light bar can light from the inner wall of the frame to the middle.

The step of middle lighting includes: disposing several double-sided lighting LED light bars in the middle of the inner portion of the advertising lamp box. The double-sided lighting LED light bars are also in the shape of a long flat strip, and two flat surfaces of the double-sided lighting LED light bar can both light. Two ends of each double-sided lighting LED light bar are fixed onto the lamp box frame, so that the LED light bar can light on two sides.

A central plane of illuminated areas of the single-sided lighting LED light bar and the double-sided lighting LED light bars is configured to be parallel to or nearly parallel to an advertising surface of the advertising lamp box. When the single-sided lighting LED light bar and the double-sided lighting LED light bars are disposed symmetrically, the central plane of illuminated areas can also be understood as a vertical plane of their light-emitting surfaces. The core of the light distribution method lies in that: unlike the conventional light distribution method for an advertising lamp box in which illumination light emitted by a light source is directly irradiated to the back of the advertising surface, the light distribution method of the present invention indirectly lights in each illumination range (that is, between the single-sided lighting LED light bar and a corresponding double-sided lighting LED light bar, or between two adjacent double-sided lighting LED light bars). The illumination light is not required to directly light on the back of the advertising surface, but light from two opposite ends respectively, thereby the illumination range is fully illuminated to further illuminate the back of the advertising surface. As such, the lighting effect of the light distribution method can be more uniform, and excessively bright or excessively dark lighting effects in local areas will not be produced. Definitely, the overall shape of the single-sided lighting LED light bar and the double-sided lighting LED light bars is not limited to the long flat strip described above, and other similar shapes that can implement such a function are also allowed.

In some embodiments, the double-sided lighting LED light bar is composed of a lamp-panel base and an LED lamp panel. There are two LED lamp panels disposed back to back on two sides of the lamp-panel base, respectively, so that the double-sided lighting LED light bar can light on two sides.

The lamp-panel base is configured to have the following structure:

The lamp-panel base includes a substrate and a first fixing groove and a second fixing groove that are disposed on two sides of the substrate. The first fixing groove and the second fixing groove each include a clamping part and a limiting part. The clamping part and the limiting part are disposed in the directions of the upper surface and the lower surface of the substrate, and more specifically, in the directions of two surfaces, which have larger surface areas, of the lamp-panel base in the shape of a long flat strip. The clamping parts, the limiting parts and the substrate coordinate with each other to form fixing parts for accommodating the LED lamp panel. The fixing part is divided into a first fixing part and a second fixing part according to positions relative to the substrate. The first fixing part and the second fixing part are formed by coordinating the substrate with the clamping part and the limiting part on either side of the upper surface or the lower surface respectively. The substrate is a straight planar sheet structure, the clamping parts extend towards directions of the upper and lower surfaces and form angles close to 90° with the substrate, and the limiting parts of the first fixing groove and the second fixing groove extend from the outer ends of the clamping parts inward and obliquely towards each other.

The first fixing part and the second fixing part each have an opening and an accommodating part. The opening is formed by oppositely extending the limiting parts of the first fixing groove and the second fixing groove, and the accommodating part is enclosed by the clamping parts of the first fixing groove and the second fixing groove and the substrate, so that the width of the opening is less than that of the accommodating part of the fixing part. In other words, the limiting parts of the first fixing groove and the second fixing groove are disposed to extend towards each other, so that the opening is smaller than the accommodating part.

The LED lamp panel includes a PCB board, LED lamp beads and lenses. The PCB board is provided with an LED operating circuit, which includes, but is not limited to, a resistor, a capacitor, a circuit and other necessary components. There are several LED lamp beads sequentially arranged on the PCB board, and the lenses are disposed on the PCB board one-to-one corresponding to the LED lamp beads, so that the PCB board, the LED lamp beads and the lenses can form the LED lamp panel for lighting after combination. The lenses each include a truncated conical light distribution body and a fixture seat disposed below the light distribution body, and the fixture seat is larger than the light distribution body. The fixture seat may be cubic or cylindrical or both. A bottom surface of the fixture seat is provided with several positioning columns, and the PCB board is correspondingly provided with positioning holes matched with the positioning columns at the bottom surface of the fixture seat of the lens. The positioning columns and the positioning holes mutually matched with each other prevent the displacement of the lens along the surface of the PCB board.

The first fixing groove and the second fixing groove each further include a thread groove. The thread groove is disposed in the middle of the first fixing groove or the second fixing groove, and includes two ribs and a cylindrical through groove disposed between the two ribs. The cylindrical through groove is formed by a gap between the two ribs. The lamp-panel base is provided with block pieces of the base disposed on two ends of, and the block pieces of the base are provided with fixing holes so that they are fixed in two ends of the through groove of the thread groove via the fixing screws. The block pieces of the base are mainly used to block off two ends of the LED lamp panel after the LED lamp panel is mounted in the fixing part, thereby firmly fixing the LED lamp panel and its components in the fixing part. The LED lamp panel further includes a wire clip. The wire clip is provided with a line hole for wires to pass through and a fixing groove for fixing the wire clip. The fixing groove is fitted to the extending part to allow the wire clip to be slidably fitted in the first fixing part or the second fixing part. The wire clip is fitted on the lamp-panel base to fix a power line of the LED lamp panel.

The first fixing groove and the second fixing groove each further include two fins (the first fixing groove and the second fixing groove each have two fins disposed on the top and bottom). One end of each fin is fixed to a junction of the clamping part and the limiting part and the other end of the fin extends outwards, and an L-shaped bend is formed at the outer end of the fin (that is, the end that extends outwards). The profile of the four fins is configured so that the lamp-panel base is still integrally in the shape of a long flat strip, that is, the sectional thickness of the lamp-panel base remains unchanged and only the width is increased. Upper and lower fins of the first fixing groove or the second fixing groove are coordinated to form a chute for fixing the entire LED light bar. More exactly, the chute is formed by coordinating the L-shaped bends at outer ends of the upper and lower fins of the first fixing groove or the second fixing groove. An LED light bar fixing device is fitted in the chute. The LED light bar fixing device includes an extending member and a fixing screw. A first end of the extending member is strip-shaped and is slidably fitted in the chute. The first end is provided with a fixing hole for disposing the fixing screw, and a second end of the extending member is provided with a mounting hole. Since the double-sided LED light bar is generally mounted along an end face, the extending member is integrally configured to be L-shaped, and the first end and the second end are end-to-end connected and form an angle of 90° or close to 90°, so that the extending member can be used to fix the LED light bar to a to-be-fixed position at its end portion.

Components of the lamp-panel base, that is, the substrate, the first fixing groove, the second fixing groove, the thread groove and the fins, are formed as a whole and are integrally manufactured by aluminum alloy extrusion or machining. On the one hand, such a structure can further enhance the mechanical strength of the lamp-panel base; on the other hand, it also provides a possibility for the setting of relevant accessories of the lamp-panel base or the fixation of the lamp-panel base, so that the lamp-panel base has stronger mechanical properties and the LED lamp can have a longer length without bending and deformation. It is conducive to promoting the overall heat dissipation performance of the LED lamp. Moreover, the structures of the clamping parts, the limiting parts, the fins and the fixing grooves in the structure and their setting positions greatly improve the overall structural strength of the lamp-panel base. This makes it possible for the LED lamp to be manufactured into a long length so as to be suitable for large billboards.

The first fixing part and the second fixing part are configured to be capable of integrally accommodating the PCB board and fixture seats of the lenses, that is, the clearance size between the limiting parts and the substrate can accommodate the thicknesses of the PCB board and the fixture seats of the lenses. A distance between two clamping parts (the clamping parts of the first fixing groove and the second fixing groove) can allow the PCB board and the fixture seats of the lenses to be disposed therein. Accordingly, the lenses and the PCB board can be firmly fixed onto the lamp-panel base.

In some other embodiments, the single-sided lighting LED light bar is also composed of a lamp-panel base and an LED lamp panel. Moreover, the specific structure and the fitting relationship of the lamp-panel base and the LED lamp panel are the same as those of the double-sided lighting LED light bars, and their difference merely lies in that the single-sided lighting LED light bar is provided with an LED lamp panel only on one side (that is, only one of the first fixing part and the second fixing part is provided with an LED lamp panel while the other one is vacant), so that the LED light bar only can light on one side. In addition, the lamp-panel base can also make some simple structural changes so that the back surface (that is, one side without the LED lamp panel) is a flat structure. Without changing the first fixing groove and the second fixing groove structurally, the substrate can be sunk towards the back surface by an appropriate distance so that the back surface of the substrate of the lamp panel is completely flat (at the same time, the thickness of the fixing part of the lens is increased correspondingly), or the substrate is unchanged but related structures of the first fixing groove and the second fixing groove are contracted correspondingly. In the former manner, the overall sizes of the single-sided lighting LED light bar and the double-sided lighting LED light bars remain unchanged and the thickness of LED lamp panel needs to be increased correspondingly. In the latter manner, the single-sided lighting LED light bar and the double-sided lighting LED light bars differ from each other slightly in the thickness, but their LED lamp panels are exactly the same in the specification. In general, the most economical solution is to make the back surface vacant.

In some preferred embodiments, the single-sided lighting LED light bars and the double-sided lighting LED light bars are configured to be uniformly disposed in the advertising lamp box, and each illumination range is configured to have a width of 2-3 m. More preferably, a distance between a single-sided lighting LED light bar and a double-sided lighting LED light bars or a distance between two adjacent double-sided lighting LED light bars is configured to be 2-3 m.

An advertising lamp box is provided. The advertising lamp box includes a box body and a lighting system. The LED light distribution lamps are disposed in the box body by the light distribution method described above. In other words, the advertising lamp box includes a box body and LED light distribution lamps. The box body is generally cubic or approximately cubic (e.g., having rounded corners), and can be a complete box body or a frame that does not include an advertising placement surface. The LED light distribution lamps include double-sided LED light bars and single-sided LED light bars. The single-sided LED light bars are mounted to two ends of the box body in such a way that the illuminated area is towards the inside of the box body and the back surface faces the wall of the box body, while the double-sided LED light bars are mounted in the middle of the inner portion of the box body in such a way that two sides face two box walls respectively. It should be noted that in principle, mounting directions of the LED light distribution lamps do not need to be strictly required, as long as the LED light distribution lamps are parallel to each other. They can be mounted horizontally or vertically, but generally vertical mounting is better. The specific structures of the double-sided LED light bars and the single-sided LED light bars are configured according to the manner in the light distribution method, and are not described in detail here.

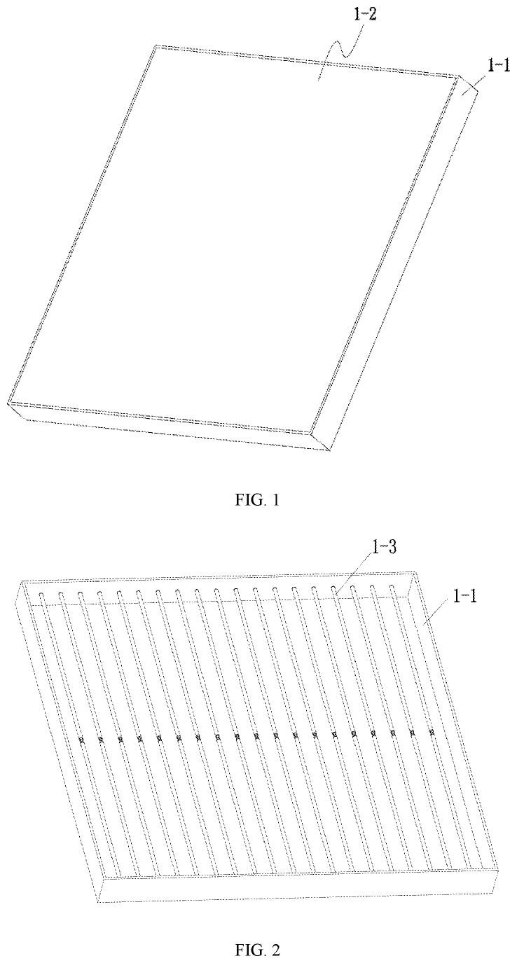

By taking the 3 m*3 m advertising lamp box shown in FIG. 1 as an example, the light distribution method of the present invention is compared with the conventional light distribution for a fluorescent lamp box and the existing light distribution using LED light bars, which is specifically as follows:

First of all, as shown in FIG. 1, an overall structural layout of the 3 m*3 m advertising lamp box integrally a structure of a cube surrounded by rectangular frames 1-1, and two surfaces 1-2 of the cube that have larger surface areas are advertising surfaces for setting advertisements. Definitely, it is also possible that there is only one advertising surface and the back is sealed. There are the following two lighting manners in the prior art for the advertising lamp box:

As shown in FIG. 2, in the first manner, 38 fluorescent lamp tubes 1-3 are used to light the 3 m*3 m advertising lamp box. Each lamp tube has a power of 58 w, and due to its size, two lamp tubes need to be connected together during mounting to meet the lighting requirements. In other words, 38 58-w fluorescent lamp tubes are configured to be 19 groups, and each group is formed by concatenation of two lamp tubes (it mainly refers to the concatenation in terms of a position relationship and specifically refers to a non-circuit connection relationship).

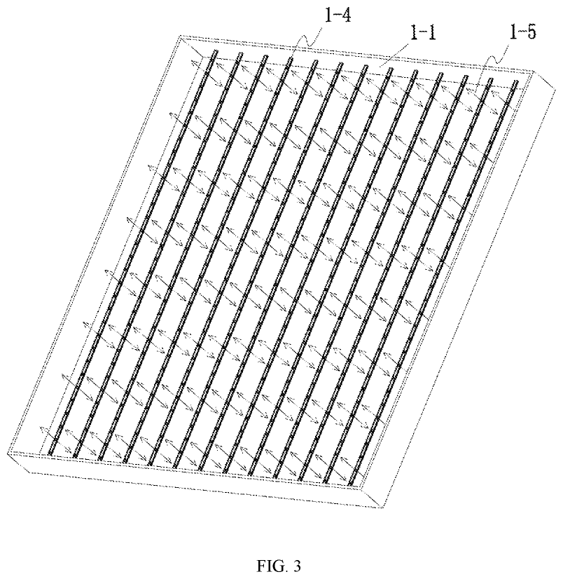

As shown in FIG. 3, in the second manner, the conventional fluorescent lamp tubes are replaced with LED lamp tubes 1-4. For the double-sided advertising lamp box shown in FIG. 3, lighting for the advertising surface can be achieved only by disposing the LED light bars in the prior art back to back. Definitely, for the single-sided advertising lamp box, it is feasible to directly fix the backs of the LED light bars to the back of the advertising lamp box. The LED light bars need to be configured with a light-emitting angle according to the direction shown by 1-5 in FIG. 3 so as to achieve a better lighting effect.

However, the above two manners each have their own inherent disadvantages. In the first manner, fluorescent lamps are used as light sources of the lighting system (light sources and accessary components), which not only has a low luminous efficiency (about 8%) and a short service life (about 3000 hours), and more importantly, uses a huge number of lamp tubes and has a very complicated mounting process since concatenation is required in each group. In the second manner, the fluorescent lamp tubes are replaced with LED light bars. The luminous efficiency has been improved (about 30%) and the service life has been significantly increased (about 30000 hours), which are caused by fixed properties of the LED light bars. However, the LED light bars also have their own defects, that is, the number of required LED light bars has been significantly increased after the fluorescent lamp tubes are replaced with existing LED light bars. In general, the same lighting effect can be achieved with a replacement ratio of at least 2:1 or higher. If the replacement is performed at an equal proportion, an obvious spot effect will be produced, which is conducive to the lighting effect of the advertising lamp box.

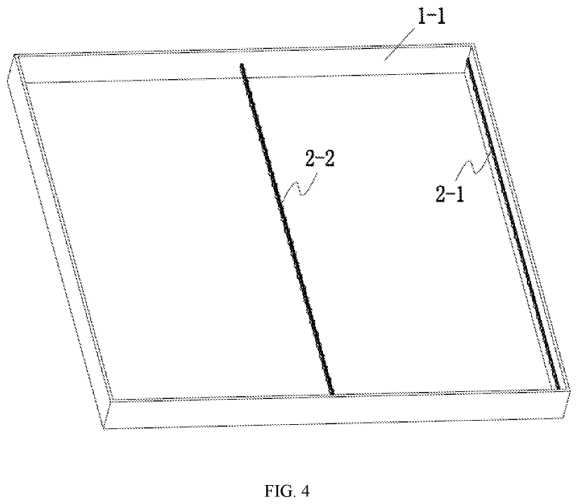

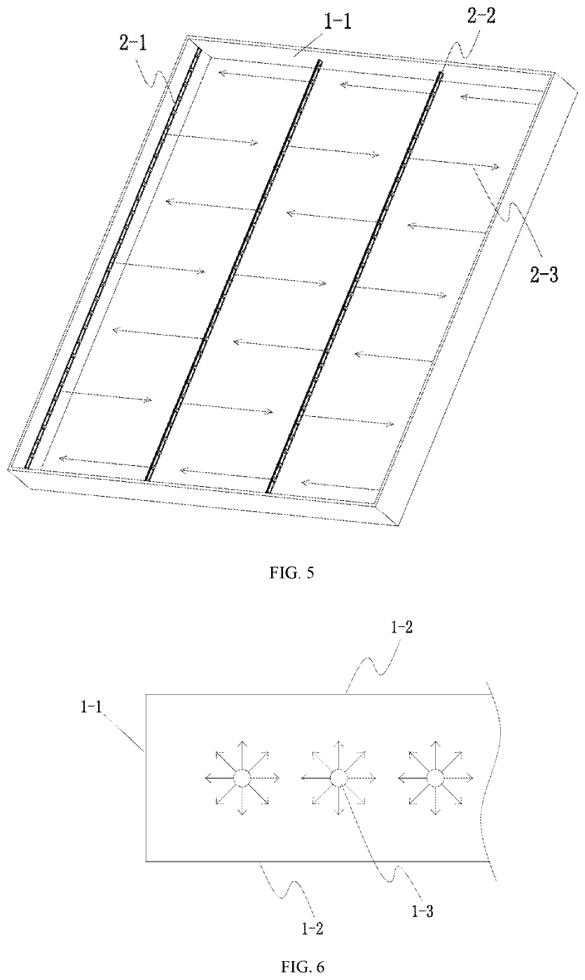

FIG. 4 and FIG. 5 are two schematic structural diagrams of an advertising lamp box on which light distribution is performed by the light distribution method according to the present invention. FIG. 4 is a schematic diagram of light distribution with the same lighting effect as that in FIG. 3, while FIG. 5 is schematic diagram of light distribution with a better effect.

Under the same condition, the light distribution method of the present invention only needs to mount components as shown in FIG. 4. That is, the single-sided lighting LED light bars according to Embodiment 2 are mounted on left and right end walls of the lamp box (the single-sided lighting LED light bars are mounted actually on the left side in FIG. 4, which are not displayed due to the angle), and a double-sided lighting LED light bar according to Embodiment 1 is mounted right in the middle of the inner portion of the lamp box. Moreover, two ends of the single-sided lighting LED light bars and the double-sided lighting LED light bars are provided with fixing devices, which, on the one hand, can be adjusted according to the actual internal size of the lamp box, and on the other hand, can be fixed to the corresponding position via self-tapping screws.

Therefore, the light distribution method of the present invention has fewer mounting steps and uses less time; moreover, single light bars can be mounted easily.

FIG. 5 shows a preferred implementation manner of a 3 m*3 m advertising lamp box that uses the light distribution method of the present invention, that is, a double-sided lighting LED light bar is further added to the lamp box (definitely, there can also be more double-sided lighting LED light bars, specifically depending on the size of the lamp box and required lighting brightness). The lighting effect can be evidently increased only by adding one double-sided lighting LED light bar.

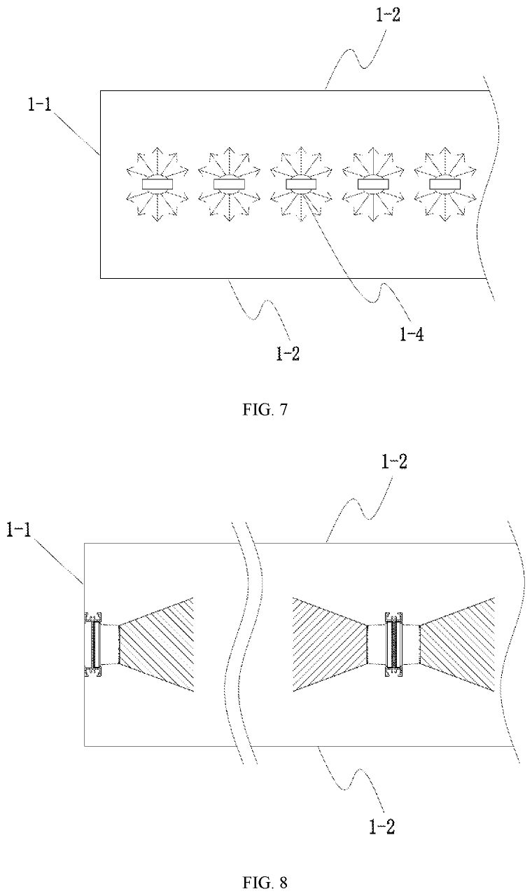

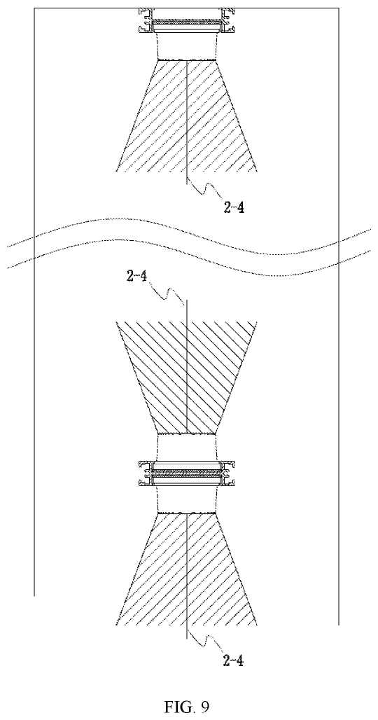

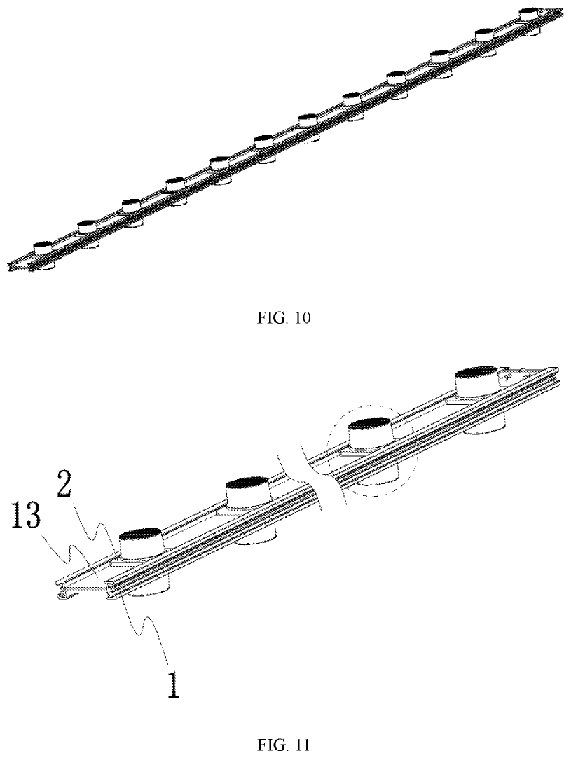

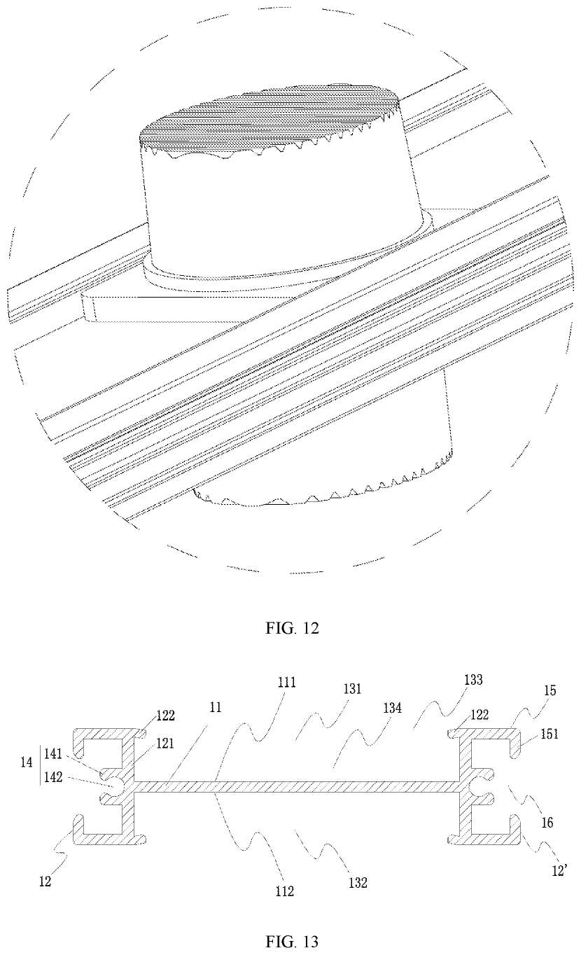

FIG. 6 to FIG. 8 are views of lighting effects of the three light distribution manners described above. The shaded part in FIG. 8 is a schematic diagram of a main lighting area according to the present invention, which is only used to show the main lighting difference and to limit the specific lighting angle. FIG. 9 shows a relative position relationship between a central plane of illuminated areas and an advertising surface 1-2.

### Embodiment 1

A light distribution method for an advertising lamp box includes a step of edge lighting and a step of middle lighting.

The step of edge lighting includes: disposing, along an inner wall of a lamp box frame 1-1 in the advertising lamp box, an LED light bar 2-1 capable of single-sided lighting (i.e., a single-sided lighting LED light bar). The single-sided lighting LED light bar 2-1 can be configured to be a long flat strip with one of the flat surfaces capable of emitting light and the other not emitting light. The single-sided lighting LED light bar is configured to be fixed onto the inner wall of the lamp box frame in a manner that an illuminated area faces the inner of the lamp box and a back surface faces the lamp box frame, so that the LED light bar can light from the inner wall of the frame to the middle.

The step of middle lighting includes: disposing several double-sided lighting LED light bars 2-2 (i.e., the double-sided lighting LED light bars) in the middle of the inner portion of the advertising lamp box. The double-sided lighting LED light bars are also in the shape of a long flat strip, and two flat surfaces of the double-sided lighting LED light bar can both light. Two ends of each double-sided lighting LED light bar are fixed onto the lamp box frame 1-1, so that the LED light bar can light on their two sides.

A central plane of illuminated areas of the single-sided lighting LED light bar 2-1 and the double-sided lighting LED light bars 2-2 is configured to be parallel to or nearly parallel to an advertising surface 1-2 of the advertising lamp box. The core of the light distribution method lies in that: in each illumination range, the illumination light does not directly light on the back of the advertising surface, but lights from at least two opposite end faces of the illumination range respectively, thereby the illumination range is fully illuminated to further illuminate the back of the advertising surface (it can be understood as that first the illumination range is illuminated by the single-sided lighting LED light bar and the double-sided lighting LED light bars and then the advertising surface is illuminated by the illumination range).

The single-sided lighting LED light bar and the double-sided lighting LED light bars each include a lamp-panel base and an LED lamp panel. The lamp-panel base and the LED lamp panel are configured to have the following structures:

The lamp-panel base 1 is integrally in the shape of a long flat strip. The lamp-panel base 1 is composed of a substrate 11 and a first fixing groove 12 and a second fixing groove 12′ that are disposed on two sides of the substrate 11. The first fixing groove 12 and the second fixing groove 12′ each include a clamping part 121 and a limiting part 122, and the clamping part 121 and the limiting part 122 are respectively disposed in the directions of the upper surface 111 and the lower surface 112 of the substrate 11 (more specifically, in the directions of two surfaces, which have larger surface areas, of the lamp-panel base 1 in the shape of a long flat strip). The clamping parts 121, the limiting parts 122 and the substrate 11 coordinate with each other to form fixing parts 13 for accommodating the LED lamp panel. Therefore, the fixing part 13 includes a first fixing part 131 and a second fixing part 132. The first fixing part 131 and the second fixing part 132 are formed by coordinating the substrate 11 with the clamping part 121 and the limiting part 122 on either side of the upper surface 111 or the lower surface 112 respectively. The substrate 11 is a straight planar sheet structure, the clamping parts 121 extend towards directions of the upper and lower surfaces and form angles close to 90° with the substrate, and the limiting parts 122 of the first fixing groove 12 and the second fixing groove 12′ extend from the outer ends of the clamping parts 121 inward and obliquely towards each other, of which the sectional structure is as shown in FIG. 13.

The first fixing part 131 and the second fixing part 132 each have an opening 133 and an accommodating part 134. The opening 133 is formed by oppositely extending the limiting parts 122 of the first fixing groove 12 and the second fixing groove 12′, and the accommodating part 134 is enclosed by the clamping parts 121 of the first fixing groove 12 and the second fixing groove 12′ and the substrate 11, so that the width of the opening 133 is less than that of the accommodating part 134 of the fixing part 13 (that is, an internal width size of the first fixing part 131 or the second fixing part 132). In other words, the limiting parts 122 of the first fixing groove 12 and the second fixing groove 12′ are disposed to extend towards each other so that the openings 133 are smaller than the accommodating parts 134.

The LED lamp panel 2 includes a PCB board 21, LED lamp beads and lenses 22. The PCB board 21 is provided with an LED operating circuit, which includes, but is not limited to, a resistor, a capacitor, a circuit and other necessary components. There are several LED lamp beads sequentially arranged on the PCB board 21, and the lenses 22 are disposed on the PCB board 21 one-to-one corresponding to the LED lamp beads, so that the PCB board, the LED lamp beads and the lenses can form the LED lamp panel 2 for lighting after combination. The lenses 22 each include a truncated conical light distribution body 221 and a fixture seat 222 disposed below the light distribution body 221, and the fixture seat 222 is larger than the light distribution body 221. The fixture seat 222 may be cubic or cylindrical or both. A bottom surface of the fixture seat 222 is provided with several positioning columns 223, and the PCB board 21 is correspondingly provided with positioning holes matched with the positioning columns 223 at the bottom surface of the fixture seat of the lens. The positioning columns 223 and the positioning holes mutually matched with each other prevent the displacement of the lens 22 along the surface of the PCB board 21.

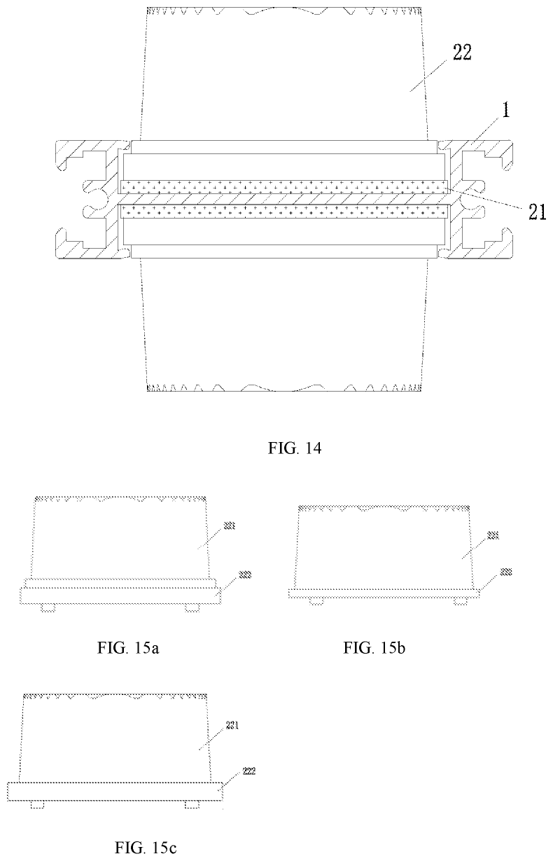

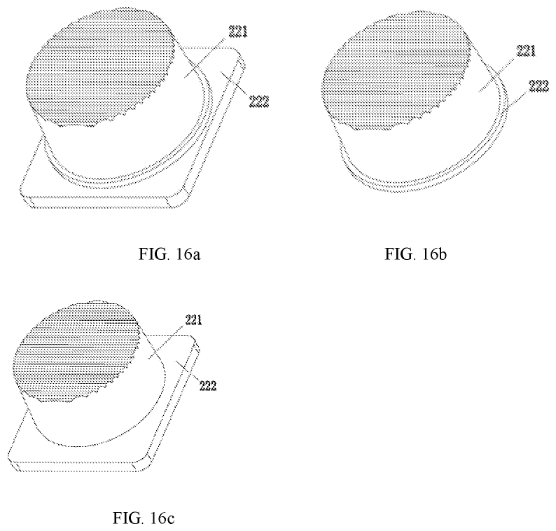

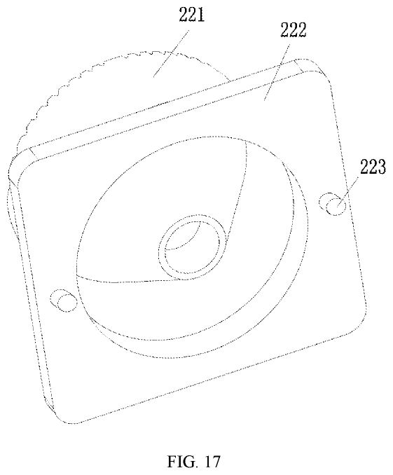

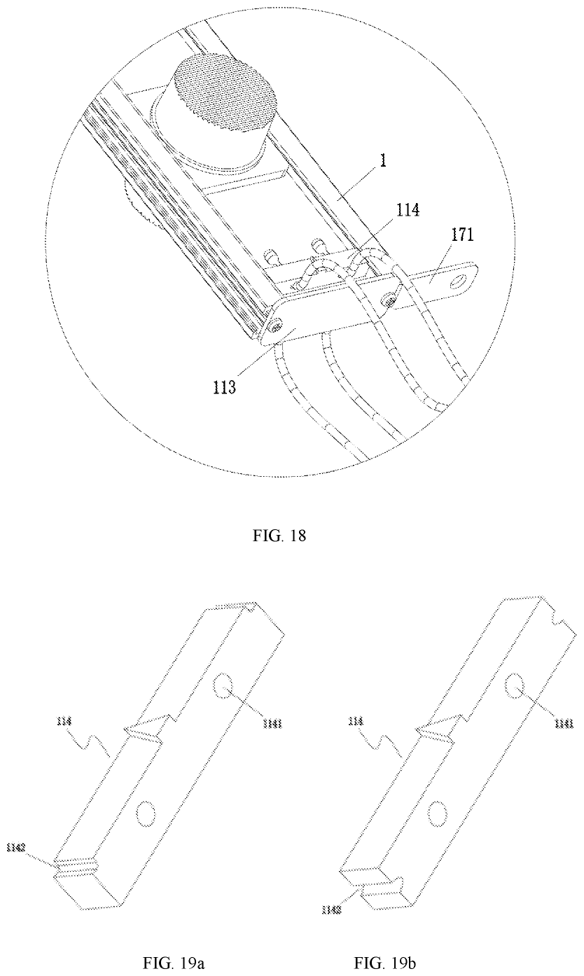

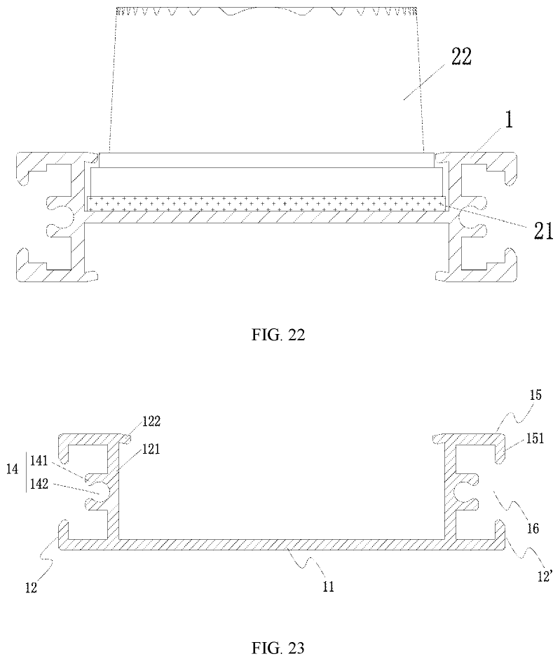

Each of the double-sided lighting LED light bars 2-2 has two LED lamp panels 2 that are disposed back to back in the first fixing part 131 and the second fixing part 132, respectively. The single-sided lighting LED light bar only has one LED lamp panel 2 that is disposed in any of the fixing parts. Sectional structures of the double-sided lighting LED light bars 2-2 and the single-sided lighting LED light bar 2-1 are as shown in FIG. 14 and FIG. 22 respectively.

The first fixing groove 12 and the second fixing groove 12′ each further include a thread groove 14 that is disposed in the middle of the first fixing groove 12 or the second fixing groove 12′. The thread groove 14 is composed of two ribs 141. A cylindrical through groove 142 is disposed between the two ribs 141. The lamp-panel base 1 is provided with block pieces 113 of the base disposed on two ends, and the block pieces 113 of the base are provided with fixing holes so that they are fixed in two ends of the through groove 142 of the thread groove via the fixing screws. The block pieces 113 of the base are mainly used to block off two ends of the LED lamp panel 2 after the LED lamp panel 2 is mounted in the fixing part 13, thereby firmly fixing the LED lamp panel 2 and its components in the fixing part 13.

The LED lamp panel further includes a wire clip 114. The wire clip 114 is provided with a line hole 1141 for wires to pass through and a fixing groove 1142 for fixing the wire clip. The fixing groove 1142 is fitted to the extending part 122 to allow the wire clip 114 to be slidably fitted in the first fixing part 131 or the second fixing part 132. After the wire clip 114 is fixed to the lamp-panel base 1, a power line of the LED lamp panel 2 can be fixed so as to prevent that a pulling force perpendicular to the surface direction of the PCB board damages an electrical connection point between the power line and the PCB board. The wire clip 114 is fixed to the lamp-panel base 1 to fix the power line of the LED lamp panel 2.

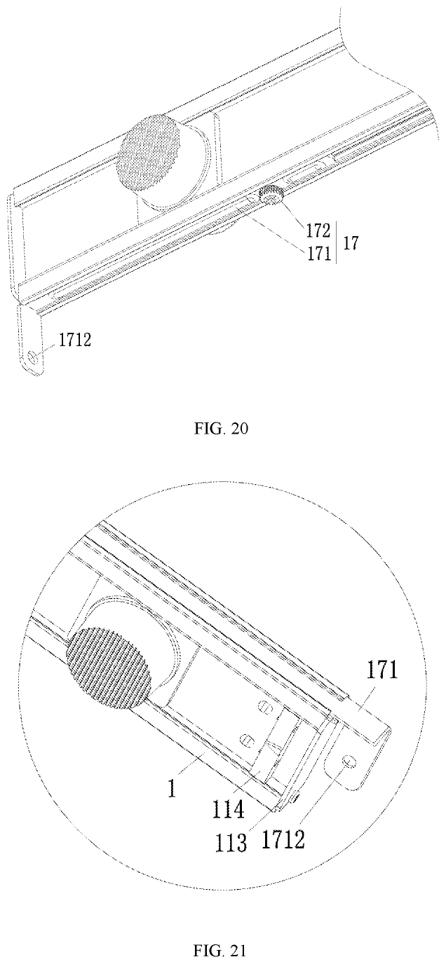

The first fixing groove 12 and the second fixing groove 12′ each further include two fins 15 (the first fixing groove 12 and the second fixing groove 12′ each have two fins disposed on the top and bottom). One end of each fin 15 is fixed to a junction of the clamping part 121 and the limiting part 122 and the other end of the fin extends outwards, and an L-shaped bend 151 is formed at the outer end of the fin (that is, the end that extends outwards). The profile of the four fins 15 is configured so that the lamp-panel base 1 is still integrally in the shape of a long flat strip, that is, the sectional thickness of the lamp-panel base remains unchanged and only the width is increased (because the fins 15 extend outwards). Upper and lower fins 15 of the first fixing groove 12 or the second fixing groove 12′ are coordinated to form a chute 16 for fixing the entire LED light bar. More exactly, the chute is formed by coordinating the L-shaped bends 151 at outer ends of the upper and lower fins 15 of the first fixing groove 12 or the second fixing groove 12′. An LED light bar fixing device 17 is fitted in the chute 16. The LED light bar fixing device 17 includes an extending member 171 and a fixing screw 172. A first end of the extending member 171 is strip-shaped and is slidably fitted in the chute 16. The first end is provided with a fixing hole for disposing the fixing screw 172, and a second end of the extending member is provided with a mounting hole 1712. The extending member 171 is integrally L-shaped, but it can specifically include two types of specific structures. In the first type of structure, the first end and the second end are end-to-end connected and form an angle of 90° or close to 90° (as shown in FIG. 20). In the second type of structure, the second end is fitted to a side of the first end, and the second end and the first end form an angle of 90° or close to 90° (as shown in FIG. 21). The former can be used to fix the LED light bar to a to-be-fixed position at its end portion so as to fix the double-sided lighting LED light bars 2-2 to the inner wall of the lamp box frame 1-1, and the latter can be used to fix the LED light bar to a to-be-fixed position on its back surface so as to fix the double-sided lighting LED light bar 2-1 to the inner wall of the lamp box frame 1-1.

Components of the lamp-panel base 1 (that is, the substrate 11, the first fixing groove 12, the second fixing groove 12′, the thread groove 14 and the fins 15) are formed as a whole and are integrally manufactured by aluminum alloy extrusion or machining. On the one hand, such a structure can further enhance the mechanical strength of the lamp-panel base; on the other hand, it also provides a possibility for the setting of relevant accessories of the lamp-panel base or the fixation of the lamp-panel base, so that the fins have stronger mechanical properties and the LED lamp can have a longer length without bending and deformation. It is conducive to promoting the overall heat dissipation performance of the LED lamp. Moreover, the structures of the clamping parts 121, the limiting parts 122, the fins 123 and the fixing grooves 124 in the structure and their setting positions greatly improve the overall structural strength of the lamp-panel base 1. This makes it possible for the LED lamp to be manufactured into a long length so as to be suitable for large billboards.

The first fixing part 131 and the second fixing part 132 are configured to be capable of integrally accommodating the PCB board 21 and fixture seats 222 of the lenses 22, that is, the clearance size between the limiting parts 122 and the substrate 11 can accommodate the thicknesses of the PCB board 21 and the fixture seats 222 of the lenses 22. A distance between two clamping parts 121 (the clamping parts of the first fixing groove and the second fixing groove) can allow the PCB board 21 and the fixture seats of the lenses 22 to be disposed therein. Accordingly, the lenses 22 and the PCB board 21 can be firmly fixed onto the lamp-panel base 1 (as the LED lamp beads are disposed on the PCB board 21, they are also located on the lamp-panel base 1, in other words, they can form a complete structure of the LED light bars of the present invention).

### Embodiment 2

A light distribution method for an advertising lamp box is provided. The main steps and the structure of the light bar are similar to those in Embodiment 1. The difference merely lies in that the lamp-panel base of the single-sided lighting LED light bar is configured to have a flat back surface while other structures are unchanged. In a situation where the first fixing groove and the second fixing groove are structurally unchanged, the substrate can be sunk towards the back surface by an appropriate distance so that the back surface of the substrate of the lamp panel is completely flat (at the same time, the thickness of the fixing part of the lens is increased correspondingly), or the substrate is unchanged but related structures of the first fixing groove and the second fixing groove are contracted correspondingly, of which the sectional structure is as shown in FIG. 23. In the former manner, the overall size of the single-sided lighting LED light bar and the double-sided lighting LED light bars remain unchanged and the thickness of LED lamp panel needs to be increased correspondingly. In the latter manner, the single-sided lighting LED light bar and the double-sided lighting LED light bars differ from each other slightly in the thickness, but their LED lamp panels are exactly the same in the specification.

### Embodiment 3

An advertising lamp box is provided. The advertising lamp box includes a box body and an LED light distribution lamp. The LED light distribution lamp is disposed in the box body according to the light distribution method described in Embodiment 1 or 2. Its specific structure is as follows:

The advertising lamp box includes a box body and a lighting system. The lighting system includes an LED light distribution lamp and some other auxiliary components. The box body is generally cubic or approximately cubic (e.g., having rounded corners), and can be a complete box body or a frame that does not include an advertising placement surface. The LED light distribution lamp includes single-sided LED light bars 2-1 and double-sided LED light bars 2-2. The double-sided lighting LED light bar 2-2 is composed of a lamp-panel base 1 and LED lamp panels 2. There are two LED lamp panels 2 disposed back to back on two sides of the lamp-panel base 1, so that the double-sided LED light bar can light on two sides. The single-sided lighting LED light bar 2-1 is composed of a lamp-panel base 1 and an LED lamp panel 2. The single-sided light LED light bar 2-1 is only provided with an LED lamp panel 2 on one side (that is, only one of the first fixing part and the second fixing part is provided with an LED lamp panel while the other one is vacant), so that the LED light bar only can light on one side. Specific structures of composition units (the lamp-panel base 1 and the LED lamp panel 2) of the single-sided LED light bars 2-1 and double-sided LED light bars 2-2 are the same, and the difference merely lies in different numbers of LED lamp panels 2 matched with each lamp-panel base 1. Definitely, the structure of the double-sided lighting LED light bars may also be slightly changed (as shown in FIG. 23).

The lamp-panel base 1 is integrally in the shape of a long flat strip. The lamp-panel base 1 is composed of a substrate 11 and a first fixing groove 12 and a second fixing groove 12′ that are disposed on two sides of the substrate 11. The first fixing groove 12 and the second fixing groove 12′ each include a clamping part 121 and a limiting part 122, and the clamping part 121 and the limiting part 122 are respectively disposed in the directions of the upper surface 111 and the lower surface 112 of the substrate 11 (more specifically, in the directions of two surfaces, which have larger surface areas, of the lamp-panel base 1 in the shape of a long flat strip). The clamping parts 121, the limiting parts 122 and the substrate 11 coordinate with each other to form fixing parts 13 for accommodating the LED lamp panel. Therefore, the fixing part 13 includes a first fixing part 131 and a second fixing part 132. The first fixing part 131 and the second fixing part 132 are formed by coordinating the substrate 11 with the clamping part 121 and the limiting part 122 on either side of the upper surface 111 or the lower surface 112 respectively. The substrate 11 is a straight planar sheet structure, the clamping parts 121 extend towards directions of the upper and lower surfaces and form angles close to 90° with the substrate, and the limiting parts 122 of the first fixing groove 12 and the second fixing groove 12′ extend from the outer ends of the clamping parts 121 inward and obliquely towards each other, of which the sectional structure is as shown in FIG. 13.

The first fixing part 131 and the second fixing part 132 each have an opening 133 and an accommodating part 134. The opening 133 is formed by oppositely extending the limiting parts 122 of the first fixing groove 12 and the second fixing groove 12′, and the accommodating part 134 is enclosed by the clamping parts 121 of the first fixing groove 12 and the second fixing groove 12′ and the substrate 11, so that the width of the opening 133 is less than that of the accommodating part 134 of the fixing part 13 (that is, an internal width size of the first fixing part 131 or the second fixing part 132). In other words, the limiting parts 122 of the first fixing groove 12 and the second fixing groove 12′ are disposed to extend towards each other so that the openings 133 are smaller than the accommodating parts 134.

The LED lamp panel 2 includes a PCB board 21, LED lamp beads and lenses 22. The PCB board 21 is provided with an LED operating circuit, which includes, but is not limited to, a resistor, a capacitor, a circuit and other necessary components. There are several LED lamp beads sequentially arranged on the PCB board 21, and the lenses 22 are disposed on the PCB board 21 one-to-one corresponding to the LED lamp beads, so that the PCB board, the LED lamp beads and the lenses can form the LED lamp panel 2 for lighting after combination. The lenses 22 each include a truncated conical light distribution body 221 and a fixture seat 222 disposed below the light distribution body 221, and the fixture seat 222 is larger than the light distribution body 221. The fixture seat 222 may be cubic or cylindrical or both. A bottom surface of the fixture seat 222 is provided with several positioning columns 223, and the PCB board 21 is correspondingly provided with positioning holes matched with the positioning columns 223 at the bottom surface of the fixture seat of the lens. The positioning columns 223 and the positioning holes mutually matched with each other prevent the displacement of the lens 22 along the surface of the PCB board 21.

The first fixing groove 12 and the second fixing groove 12′ each further include a thread groove 14. The thread groove 14 is disposed in the middle of the first fixing groove 12 or the second fixing groove 12′, and composed of two ribs 141. A cylindrical through groove 142 is disposed between the two ribs 141. The lamp-panel base 1 is provided with block pieces 113 of the base disposed on two ends, and the block pieces 113 of the base are provided with fixing holes so that they are fixed in two ends of the through groove 142 of the thread groove via the fixing screws. The block pieces 113 of the base are mainly used to block off two ends of the LED lamp panel 2 after the LED lamp panel 2 is mounted in the fixing part 13, thereby firmly fixing the LED lamp panel 2 and its components in the fixing part 13.

The LED lamp panel further includes a wire clip 114. The wire clip 114 is provided with a line hole 1141 for wires to pass through and a fixing groove 1142 for fixing the wire clip. The fixing groove 1142 is fitted to the extending part 122 to allow the wire clip 114 to be slidably fitted in the first fixing part 131 or the second fixing part 132. After the wire clip 114 is fixed to the lamp-panel base 1, a power line of the LED lamp panel 2 can be fixed so as to prevent that a pulling force perpendicular to the surface direction of the PCB board damages an electrical connection point between the power line and the PCB board.

The first fixing groove 12 and the second fixing groove 12′ each further include two fins 15 (the first fixing groove 12 and the second fixing groove 12′ each have two fins disposed on the top and bottom). One end of each fin 15 is fixed to a junction of the clamping part 121 and the limiting part 122 and the other end of the fin extends outwards, and an L-shaped bend 151 is formed at the outer end of the fin (that is, the end that extends outwards). The profile of the four fins 15 is configured so that the lamp-panel base 1 is still integrally in the shape of a long flat strip, that is, the sectional thickness of the lamp-panel base remains unchanged and only the width is increased (because the fins 15 extend outwards). Upper and lower fins 15 of the first fixing groove 12 or the second fixing groove 12′ are coordinated to form a chute 16 fixing the entire LED light bar. More exactly, the chute is formed by coordinating the L-shaped bends 151 at outer ends of the upper and lower fins 15 of the first fixing groove 12 or the second fixing groove 12′. An LED light bar fixing device 17 is fitted in the chute 16. The LED light bar fixing device 17 includes an extending member 171 and a fixing screw 172. A first end of the extending member 171 is strip-shaped and is slidably fitted in the chute 16. The first end is provided with a fixing hole for disposing the fixing screw 172, and a second end of the extending member is provided with a mounting hole 1712. The first end of the extending member 171 and a primary surface of the second end form an angle of 90° or close to 90°.

Components of the lamp-panel base 1 (that is, the substrate 11, the first fixing groove 12, the second fixing groove 12′, the thread groove 14 and the fins 15) are formed as a whole and are integrally manufactured by aluminum alloy extrusion or machining. On the one hand, such a structure can further enhance the mechanical strength of the lamp-panel base; on the other hand, it also provides a possibility for the setting of relevant accessories of the lamp-panel base or the fixation of the lamp-panel base, so that the fins have stronger mechanical properties and the LED lamp can have a longer length without bending and deformation. It is conducive to promoting the overall heat dissipation performance of the LED lamp. Moreover, the structures of the clamping parts 121, the limiting parts 122, the fins 123 and the fixing grooves 124 in the structure and their setting positions greatly improve the overall structural strength of the lamp-panel base 1. This makes it possible for the LED lamp to be manufactured into a long length so as to be suitable for large billboards.

The first fixing part 131 and the second fixing part 132 are configured to be capable of integrally accommodating the PCB board 21 and fixture seats 222 of the lenses 22, that is, the clearance size between the limiting parts 122 and the substrate 11 can accommodate the thicknesses of the PCB board 21 and the fixture seats 222 of the lenses 22. A distance between two clamping parts 121 (the clamping parts of the first fixing groove and the second fixing groove) can allow the PCB board 21 and the fixture seats of the lenses 22 to be disposed therein. Accordingly, the lenses 22 and the PCB board 21 can be firmly fixed onto the lamp-panel base 1 (as the LED lamp beads are disposed on the PCB board 21, they are also located on the lamp-panel base 1, in other words, they can form a complete structure of the LED light bars of the present invention).

The single-sided LED light bars 2-1 are mounted to left and right ends (or up and down or around) of the box body in a manner that the illuminated area faces the inside of the box body and the back surface faces the wall of the box body. The double-sided LED light bars 2-2 are mounted to the top and the bottom of the middle of the inner portion of the box body in a manner that two sides face two box walls respectively. The single-sided LED light bars 2-1 and the double-sided LED light bars 2-2 are vertically (or horizontally) mounted in the lamp box.

The light distribution method of the present invention and the advertising lamp box obtained therefrom are obviously improved in terms of energy consumption and working hours required for mounting (maintenance) compared with the mainstream fluorescent lamps. Compared with the existing light distribution manner directly using the LED light bars, the energy consumption and total wattage of the two are relatively close (based on the principle of energy conservation), but the structure and light distribution manner of the light bars are obviously different. In the existing light distribution manner, LED beads are uniformly arranged under the advertising surface to illuminate the advertising surface. Therefore, the number of the LED beads in a single light bar is relatively small. However, the light distribution method of the present invention is different. The number of the lamp beads disposed on a single LED light bar of the present invention is generally at least four times or more than the former, and the lighting manner of the light bar is changed so that the mounting time is significantly shortened with the same lighting effect. At present, the labor cost accounts for about 40% for the mounting of lamp boxes in the market, and the light distribution method of the present invention can save at least 70% of the labor cost. In other words, the overall cost of the lamp box is reduced by about 30% after the light distribution method of the present invention is adopted.

At the same time, the temperature of the LED light bar of the present invention is maintained at 50-75° C. after working for a long time, which is much lower than the limit operating temperature of 125° C. allowed by the LED lamp.

In conclusion, compared with the conventional manner, the light distribution method and the advertising lamp box of the present invention have a lower overall cost of mounting of the lamp box and significantly improved product yield.

1. A light distribution method for an advertising lamp box, comprising a step of edge lighting and a step of middle lighting, wherein
the step of edge lighting comprises: disposing, along an inner wall of a lamp box frame in the advertising lamp box, an LED light bar capable of single-sided lighting, wherein the single-sided lighting LED light bar is configured to be fixed onto the inner wall of the lamp box frame in a manner that an illuminated area faces the inner of the lamp box and a back surface faces the lamp box frame, so that the LED light bar can light from the inner wall of the frame to the middle;
the step of middle lighting comprises: disposing several double-sided lighting LED light bars in the middle of the inner portion of the advertising lamp box, wherein two ends of the double-sided lighting LED light bars are fixed onto the lamp box frame, so that the LED light bars can light on two sides; and
a central plane of illuminated areas of the single-sided lighting LED light bar and the double-sided lighting LED light bars is configured to be parallel to an advertising surface of the advertising lamp box, such that in each illumination range, the illumination light does not directly light on the back of the advertising surface, but lights from at least two opposite end faces of the illumination range respectively, so that the illumination range is fully illuminated to further illuminate the back of the advertising surface.

2. The light distribution method for an advertising lamp box according to claim 1, wherein the double-sided lighting LED light bars are configured to be disposed in parallel to each other.

3. The light distribution method for an advertising lamp box according to claim 2, wherein the single-sided lighting LED light bar is configured to be disposed on an inner wall of a frame parallel to the double-sided lighting LED light bars or disposed in a circle along an inner wall frame of the lamp box.

4. The light distribution method for an advertising lamp box according to claim 1, wherein
the double-sided lighting LED light bars each comprise a lamp-panel base and an LED lamp panel, the lamp-panel base comprises a substrate and a first fixing groove and a second fixing groove that are disposed on two sides of the substrate; the first fixing groove and the second fixing groove each comprise a clamping part and a limiting part, the clamping part and the limiting part are disposed in the directions of the upper surface and the lower surface of the substrate, and the clamping parts, the limiting parts and the substrate coordinate with each other to form fixing parts for accommodating the LED lamp panel; the fixing parts comprise a first fixing part and a second fixing part that are formed by coordinating the substrate with the clamping part and the limiting part on either side of the upper surface or the lower surface respectively;
the first fixing part and the second fixing part each have an opening and an accommodating part, the opening is formed by oppositely extending the limiting parts of the first fixing groove and the second fixing groove, and the accommodating part is enclosed by the clamping parts of the first fixing groove and the second fixing groove and the substrate, so that the width of the opening is less than that of the accommodating part of the fixing part;
the LED lamp panel comprises a PCB board, LED lamp beads and lenses, there are several LED lamp beads sequentially arranged on the PCB board, and the lenses are arranged on the PCB board one-to-one corresponding to the LED lamp beads, so that the PCB board, the LED lamp beads and the lenses can form the LED lamp panel for lighting after combination; the lenses each comprise a truncated conical light distribution body and a fixture seat disposed below the light distribution body, and the fixture seat is larger than the light distribution body; a bottom surface of the fixture seat and the PCB board are respectively provided with positioning mechanisms mutually matched with each other, so that the displacement of the lenses along the surface of the PCB board is prevented; and
there are two LED lamp panels disposed back to back in the first fixing part and the second fixing part, respectively, so that the LED light bars can light on two sides; and the first fixing part and the second fixing part are configured to enable the lenses and the PCB board to be firmly fixed onto the lamp-panel base.

5. The light distribution method for an advertising lamp box according to claim 4, wherein the single-sided lighting LED light bar comprises a lamp-panel base and an LED lamp panel, there is only one LED lamp panel disposed on one side of the lamp-panel base and the other side of the lamp-panel base is vacant, so that the LED light bar can light only on one side; or the lamp-panel base is configured to have a fixing part only disposed on one side and to be flat on the other side.

6. The light distribution method for an advertising lamp box according to claim 4, wherein the first fixing groove and the second fixing groove each further comprise two fins, the fins are disposed on tops and bottoms of the first fixing groove and the second fixing groove, respectively; each fin has one end fixed to the clamping part and/or the limiting part and the other end extending outwards, and an L-shaped bend is formed at an outer end of the fin.

7. The light distribution method for an advertising lamp box according to claim 5, wherein the first fixing groove and the second fixing groove each further comprise two fins, the fins are disposed on tops and bottoms of the first fixing groove and the second fixing groove, respectively; each fin has one end fixed to the clamping part and/or the limiting part and the other end extending outwards, and an L-shaped bend is formed at an outer end of the fin.

8. The light distribution method for an advertising lamp box according to claim 4, wherein upper and lower fins of the first fixing groove or the second fixing groove are coordinated to form a chute for fixing the entire LED light bar, an LED light bar fixing device is fitted in the chute, the LED light bar fixing device comprises an extending member and a fixing screw, a first end of the extending member is strip-shaped and is slidably fitted in the chute, the first end is provided with a fixing hole for disposing the fixing screw, and a second end is provided with a mounting hole.

9. The light distribution method for an advertising lamp box according to claim 5, wherein upper and lower fins of the first fixing groove or the second fixing groove are coordinated to form a chute for fixing the entire LED light bar, an LED light bar fixing device is fitted in the chute, the LED light bar fixing device comprises an extending member and a fixing screw, a first end of the extending member is strip-shaped and is slidably fitted in the chute, the first end is provided with a fixing hole for disposing the fixing screw, and a second end is provided with a mounting hole.

10. The light distribution method for an advertising lamp box according to claim 4, wherein the first fixing groove and the second fixing groove each further comprise a thread groove, the thread groove is disposed in the middle of the first fixing groove or the second fixing groove, and comprises two ribs and a cylindrical through groove disposed between the two ribs; the lamp-panel base is provided with block pieces of the base disposed on two ends, and the block pieces of the base are provided with fixing holes so that they are fixed in two ends of the through groove of the thread groove via the fixing screws, thereby blocking off two ends of the LED lamp panel after the LED lamp panel is mounted in the fixing part, and firmly fixing the LED lamp panel and its components in the fixing part.

11. The light distribution method for an advertising lamp box according to claim 5, wherein the first fixing groove and the second fixing groove each further comprise a thread groove, the thread groove is disposed in the middle of the first fixing groove or the second fixing groove, and comprises two ribs and a cylindrical through groove disposed between the two ribs; the lamp-panel base is provided with block pieces of the base disposed on two ends, and the block pieces of the base are provided with fixing holes so that they are fixed in two ends of the through groove of the thread groove via the fixing screws, thereby blocking off two ends of the LED lamp panel after the LED lamp panel is mounted in the fixing part, and firmly fixing the LED lamp panel and its components in the fixing part.

12. The light distribution method for an advertising lamp box according to claim 4, wherein components of the lamp-panel base are formed as a whole and are integrally manufactured by aluminum alloy extrusion or machining.

13. The light distribution method for an advertising lamp box according to claim 5, wherein components of the lamp-panel base are formed as a whole and are integrally manufactured by aluminum alloy extrusion or machining.

14. An advertising lamp box, comprising a box body and a lighting system, the lighting system comprising LED light distribution lamps, wherein the LED light distribution lamps are disposed in the box body by the light distribution method according to claim 1.
